(19) United States
(12) Patent Application Publication
(10) Pub. No.: US 2015/0370932 A1
(43) Pub. Date: Dec. 24, 2015

(54) REAR SEAT DESIGN AND FRONTAL IMPACT SIMULATION TOOL

(71) Applicant: Ford Global Technologies, LLC, Dearborn, MI (US)

(72) Inventors: Guosong Li, Novi, MI (US); Yan Fu, Canton, MI (US); Para Valentine Weerappuli, West Bloomfield, MI (US); Kevin Pline, Plymouth, MI (US)

(21) Appl. No.: 14/311,459

(22) Filed: Jun. 23, 2014

(51) Int. Cl. G06F 17/50; B60R 22/12

(52) U.S. Cl. CPC G06F 17/5009; B60R 22/12; G06F 17/5095

(57) ABSTRACT

A system includes receiving a vehicle characteristic, a rear seatbelt characteristic, and an occupant characteristic and simulating a frontal impact based on the received characteristics. The method further includes determining, via a computing device, an optimal location of at least one component of a rear seatbelt based at least in part on the simulated frontal impact and whether at least one criterion is satisfied.

### BACKGROUND

The New Car Assessment Program (NCAP) was created in 1979 by the US National Highway and Traffic Safety Administration. In the United States, NCAP defines a 5-star rating system for vehicles based on impact test data. Companion programs are located throughout the world including Europe (Euro NCAP), Australia and New Zealand (ANCAP), Latin America (Latin NCAP), and China (C-NCAP).

### BRIEF DESCRIPTION OF THE DRAWINGS

FIG. 1 illustrates an example system configured to simulate how a frontal impact may affect a rear seat occupant.

FIG. 2 is a block diagram illustrating example virtual restraint device component locations.

FIG. 3 is a flowchart of an example process that may be used simulate how a frontal impact may affect a rear seat occupant.

### DETAILED DESCRIPTION

An example system includes a user interface device and a processing device. The user interface device receives a user input and presents trend data. The user input may include a vehicle characteristic, a rear seatbelt characteristic, or an occupant characteristic. The processing device simulates a vehicle frontal impact based on the vehicle characteristic, the rear seatbelt characteristic, or the occupant characteristic provided. The processing device determines optimal rear seatbelt component locations based on whether the simulated frontal impact satisfies at least one criterion.

With the system and method described below, a vehicle engineer can design a rear seat that meets government safety standards, such as those defined by the New Car Assessment Program (NCAP). For example, the system and method described below help the vehicle engineer determine acceptable locations for the restraint device components used with a rear vehicle seat.

The system shown in the FIGS. may take many different forms and include multiple and/or alternate components and facilities. The exemplary components illustrated are not intended to be limiting. Indeed, additional or alternative components and/or implementations may be used.

As illustrated in FIG. 1, the system 100 includes a user interface device 105 and a processing device 110. The system 100 may be configured to model the affect a frontal impact would have on a passenger in a rear vehicle seat for a number of restraint device configurations. The configurations may be associated with the different combinations of restraint device component locations. The simulated frontal impact may be compared to criteria, and the system 100 may indicate which configurations satisfy the criteria. The criteria may be based on, e.g., third-party safety standards.

The system 100 may receive various inputs prior to executing the simulation. Examples of inputs may include vehicle characteristics, seatbelt characteristics, and rear occupant characteristics. Vehicle characteristics may include the vehicle speed at the time of the simulated frontal impact as well as information about one or more vehicle components. For example, the vehicle characteristics may define seat characteristics such as the number of seats in the vehicle, the distance between the front seats and the rear seats (i.e., rear occupant leg room), whether the rear seats include an anti-submarining feature, etc.

Seatbelt characteristics may include retractor attributes and the hardpoint locations for the seatbelt components. The refractor attributes may define various features of a modeled retractor used in the virtual seatbelt. The retractor attributes may define whether the modeled retractor includes a baseline retractor, a constant force retractor with stop, a progressive load limiter, a digressive load limiter, and an adaptive load limiter. Hardpoints may refer to locations where the seatbelt attaches to the rear seat or another part of the vehicle. Therefore, the seatbelt characteristics for a seatbelt having an anchor, D-ring, and buckle may define the locations of an anchor hardpoint, a D-ring hardpoint, and a buckle hardpoint, respectively.

The occupant characteristics may define, e.g., the size of a modeled rear seat occupant. For instance, the occupant characteristics may define the modeled rear seat occupant as a 5^{th} percentile occupant, a 50^{th} percentile occupant, a 95^{th} percentile occupant, or the like. Each percentile may be associated with the modeled occupant's height, weight, or both.

After executing the simulated frontal impact, the system 100 may output trends associated based on the configurations tested. The trends may be generated by statistical analysis including Pareto data. Moreover, the system 100 may provide the user with the hardpoint location combinations and retractor attributes that satisfy the safety criteria.

The restraint device configurations may be modeled for various vehicle types. The modeled vehicle may include any passenger or commercial vehicle such as a car, a truck, a sport utility vehicle, a taxi, a bus, etc. In some possible approaches, as discussed below, the vehicle is an autonomous vehicle configured to operate in an autonomous (e.g., driverless) mode, a partially autonomous mode, and/or a non-autonomous mode.

The user interface device 105 may be configured to present information to a user such as an engineer tasked with designing a restraint device for a rear vehicle seat. The restraint device may include, e.g., a seatbelt with various hardpoints. The user interface device 105 may be further configured to receive user inputs. As discussed above, examples of user inputs may include vehicle characteristics, seatbelt characteristics, or occupant characteristics. The user interface device 105 may include any number of input and output devices. Examples of input devices may include a keyboard, mouse, or trackpad. Examples of output devices may include a monitor or other display screen. In some possible approaches, the input and output devices may be combined into, e.g., a touch-sensitive display screen.

The processing device 110 may be configured to simulate the vehicle frontal impact based on user inputs received via the user interface device 105. In simulating the vehicle frontal impact, the processing device 110 may consider, therefore, the vehicle characteristics, the rear seatbelt characteristics, and the occupant characteristics. The processing device 110 may execute the simulation for multiple rear seatbelt configurations. Each configuration, as discussed above, may examine different combinations of hardpoint locations and retractor attributes. The processing device 110 may generate trend data in accordance with the frontal impact. The trend data may be based on, e.g., a Pareto analysis.

The processing device 110 may be configured to compare the simulation results to predetermined criteria and identify the combinations of hardpoint locations and refractor attributes that satisfy the criteria. In some possible approaches, the processing device 110 may further rank the combinations according to how well the criteria are satisfied. The processing device 110 may output the combinations to the user interface device 105 for presentation to the user.

Alternatively or in addition, the processing device 110 may output the trend data via the user interface device 105. The trend data may indicate to the user which hardpoint location, retractor attribute, or both, should be adjusted to comply with one or more criterion. The processing device 110 may receive a new hardpoint location or refractor attribute, which may be provided manually by the user via the user interface device 105, execute the simulation with the new parameters, and output the latest trend data. This process may repeat until the user is satisfied that all criteria are met.

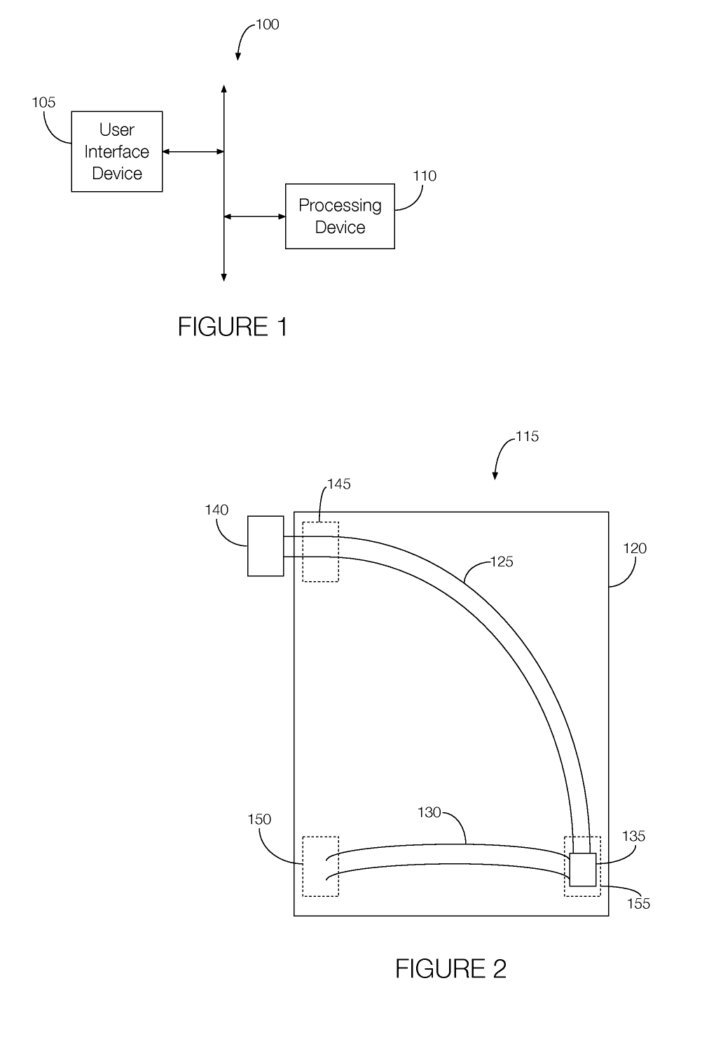

FIG. 2 is a block diagram illustrating example locations of virtual restraint device 115 components relative to a virtual seat 120. As shown, the virtual restraint device 115 includes a shoulder belt portion 125, a lap belt portion 130, a buckle 135, and a retractor 140. The shoulder belt portion 125 may attach to the rear seat at the anchor hardpoint. The lap belt portion 130 may attach to the rear seat at the D-ring hardpoint. The buckle 135 may attach to the rear seat at the buckle hardpoint. The retractor 140 may be disposed on or near the seat, and the shoulder belt portion 125 may extend from the retractor 140. The shoulder belt portion 125 and the lap belt portion 130 may be configured to plug into the buckle 135 via an insert.

The system 100 may define predetermined zones for each hardpoint location. A first zone 145 may be associated with the anchor hardpoint location, a second zone 150 may be associated with the D-ring hardpoint location, and a third zone 155 may be associated with the buckle hardpoint location. The system 100 may be configured to receive a user selection of points within each zone. The selected points may represent the hardpoint locations to be tested for each zone. Alternatively or in addition, default points may be designated for each zone, and the user may be permitted to select new points to replace or supplement the default points. After executing the simulation, the system 100 may indicate which points or combinations of points satisfy the criteria, as discussed above.

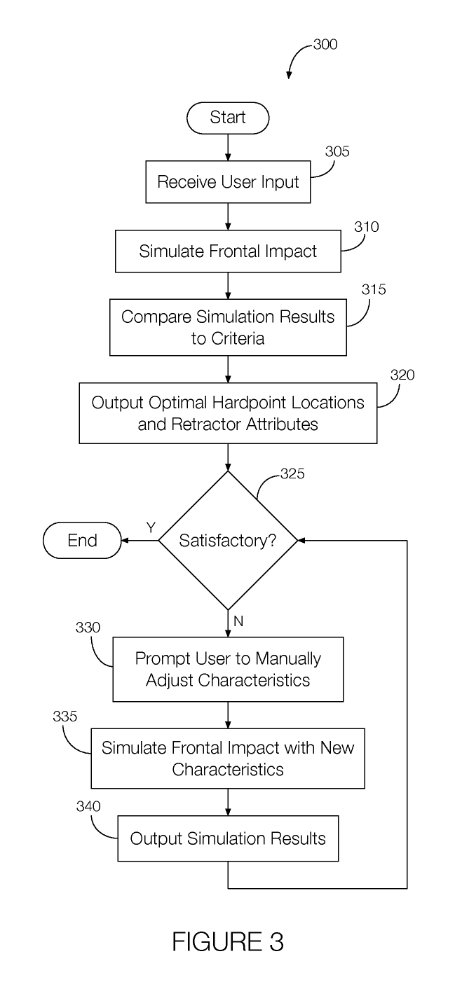

FIG. 3 is a flowchart of an example process that may be used simulate how a frontal impact may affect a rear seat occupant. The process may be executed by, e.g., the processing device 110 alone or in combination with other system 100 components.

At block 305, the processing device 110 may receive the user input. As discussed above, the user input may include the vehicle characteristics, the rear seatbelt characteristics, and the occupant characteristics. These characteristics may be based on user inputs provided to the user input device. The user interface device 105 may transmit the user inputs to the processing device 110 or store the characteristics in a memory device accessible to the processing device 110.

At block 310, the processing device 110 may simulate the frontal impact. The simulation may consider various combinations of vehicle characteristics, rear seatbelt chracteristics, and occupant characteristics. In some possible approaches, the vehicle characteristics and occupant characteristics may remain constant while the rear seatbelt characteritics—in particular the locations of the hardpoints and the retractor attributes—are changed.

At block 315, the processing device 110 may compare the simulation results to criteria. As discussed above, the criteria may be based on third-party safety ratings. In some instances, the processing device 110 may rank the simulation results according to how well each combination of characteristics satisfies the criteria. Alternatively, the processing device 110 may generate trend data using, e.g., a Pareto analysis for each combination of characteristics.

At block 320, the processing device 110 may determine and output the optimal hardpoint locations and retractor attributes for the combinations simulated. For instance, the procssing device may select the combination with the highest rank at block 315 or the combination that requires the least amount of adjustment to comply with the criteria based on the Pareto analysis. The processing device 110 may output the results of the simulation to the user interface device 105. The results of the simulation may include the optimal hardpoint locations and refractor attributes, the trend data for each combination simulated, or both.

At decision block 325, the processing device 110 may prompt the user to indicate whether the simulation results are satisfactory. If so, the process 300 may end. Otherwise, the process 300 may continue at block 330.

At block 330, the processing device 110 may prompt the user to manually adjust one or more rear seatbelt characteristics. The manual adjustment may be made via user inputs provided to the user interface device 105 and may include a selection of different points within each of the zones described above with reference to FIG. 2. Alternatively or in addition, the manual adjustment may include a selection of different retractor attributes.

At block 335, the processing device 110 may simulate the frontal impact with the manually entered rear seatbelt characteristics provided at block 330.

At block 340, the processing device 110 may output the simulation results from block 335 to the user interface device 105. The process 300 may continue at block 325 to permit the user to make further manual adjustments if desired.

In general, computing systems and/or devices described above may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
receiving a vehicle characteristic, a rear seatbelt characteristic, and an occupant characteristic;
simulating a frontal impact based at least in part on the vehicle characteristic, the rear seatbelt characteristic, and the occupant characteristic; and
determining, via a computing device, an optimal location of at least one component of a rear seatbelt based at least in part on the simulated frontal impact and whether at least one criterion is satisfied.

2. The method of claim 1, further comprising comparing a result of the simulated frontal impact to the at least one criterion.

3. The method of claim 1, wherein the rear seatbelt characteristic includes a location of at least one of an anchor hardpoint, a buckle hardpoint, and a D-ring hardpoint.

4. The method of claim 1, wherein the rear seatbelt characteristic defines an attribute associated with a retractor.

5. The method of claim 1, wherein the simulated frontal impact includes a simulation of a vehicle rear seat during the frontal impact.

6. The method of claim 1, wherein the vehicle characteristic includes at least one of a spacing between a rear seat and a front seat and a vehicle speed.

7. The method of claim 1, wherein the vehicle characteristic indicates whether a rear seat has an anti-submarining ramp.

8. The method of claim 1, wherein the occupant characteristic includes a size of an occupant.

9. The method of claim 1, further comprising generating trend data in accordance with the simulated frontal impact.

10. The method of claim 9, further comprising displaying the trend data via a user interface device.

11. A system comprising:
a user interface device configured to receive a user input and present trend data, wherein the user input includes at least one of a vehicle characteristic, a rear seatbelt characteristic, and an occupant characteristic;
a processing device configured to simulate a vehicle frontal impact based at least in part on the vehicle characteristic, the rear seatbelt characteristic, and the occupant characteristic, wherein the processing device is configured to determine an optimal location of at least one component of a rear seatbelt based at least in part on the simulated frontal impact and whether at least one criterion is satisfied.

12. The system of claim 11, wherein the processing device is configured to compare a result of the simulated frontal impact to the at least one criterion.

13. The system of claim 11, wherein the rear seatbelt characteristic includes at least one of:
a location of at least one of an anchor hardpoint, a buckle hardpoint, and a D-ring hardpoint; and
an attribute associated with a retractor.

14. The system of claim 11, wherein the simulated frontal impact includes a simulation of a vehicle rear seat during the frontal impact.

15. The system of claim 11, wherein the vehicle characteristic includes at least one of a spacing between a rear seat and a front seat and a vehicle speed.

16. The system of claim 11, wherein the vehicle characteristic indicates whether a rear seat has an anti-submarining ramp.

17. The system of claim 11, wherein the occupant characteristic includes a size of an occupant.

18. The system of claim 11, wherein the processing device is configured to generate trend data in accordance with the simulated frontal impact.

19. The system of claim 18, wherein the user interface device is configured to display the trend data.

20. A non-transitory computer readable medium tangibly embodying computer-executable instructions executable by a processor of a computing device to provide operations comprising:
receiving a vehicle characteristic, a rear seatbelt characteristic, and an occupant characteristic;
simulating a frontal impact based at least in part on the vehicle characteristic, the rear seatbelt characteristic, and the occupant characteristic; and
determining an optimal location of at least one component of a rear seatbelt based at least in part on the simulated frontal impact and whether at least one criterion is satisfied.
